(19) United States
(12) Patent Application Publication
(10) Pub. No.: US 2013/0281124 A1
(43) Pub. Date: Oct. 24, 2013

(54) METHOD FOR THE AUTOMATED DETECTION OF THE LOCAL POSITION OF A PERSON

(71) Applicant: SCHEIDT & BACHMANN GMBH, Monchengladbach (DE)

(72) Inventors: Heinz LAUMEN, Gangelt (DE); Norbert MILLER, Monchengladbach (DE)

(73) Assignee: Scheidt & Bachmann GmbH, Monchengladbach (DE)

(21) Appl. No.: 13/790,425

(22) Filed: Mar. 8, 2013

(30) Foreign Application Priority Data
Apr. 24, 2012 (EP) 12165371.1

(51) Int. Cl. H04W 4/02

(52) U.S. Cl. CPC H04W 4/02
USPC 455/456.3; 455/456.1

(57) ABSTRACT

In order to provide a method for the automated detection of a local position, which enables a largely automated detection of the use of fee-based services and can be used as base for automated billings, a method is provided for the automated detection of a local position of a person equipped with suitable terminals and sensors, wherein at respectively comparable times geographic data as well as at least one type of acceleration information and/or surrounding field information is collected which will then be evaluated by means of memorized reference data of the geographical place, the acceleration and the surrounding field.

### CROSS-REFERENCE TO RELATED APPLICATIONS

This application claims the benefit and priority of European Patent Application No. 12165371.1 filed Apr. 24, 2012. The entire disclosure of the above application is incorporated herein by reference.

### BACKGROUND OF THE INVENTION

1. Technical Field

The present invention relates to a method for the automated detection of the local position of a person.

2. Discussion

Methods are known in the state of the art, for example from the field of execution of custodial sentences, wherein a person is provided with a radio transmitter. This transmitter can be unequivocally detected, localized and identified, such that the person's local position can be detected at any time by corresponding monitoring means.

In given surroundings, for example high security areas, it is furthermore possible to detect the presence of persons in special areas. Supervisory staff can thus detect the local position of an individual, for example by a linkage to video information. An automated detection is not possible.

The adaptation of such and similar systems for the detection of the local position of a person, for example in order to detect the use of locally defined services as in the fare management or for systems in parking garages, is however complicated and requires specific hardware components which makes these systems costly.

In the field of mobile phones it is known that it is possible to detect at any time in which radio cell a particular mobile terminal is used.

There is however a high demand for largely automated systems for the continuous detection of local positions of a person in order to be consequently able to reliably detect used services. Application fields in which persons use services to be charged fall within this scope. They cover the use of means of transportation, the use of chargeable areas, for example driving on toll-based streets, the use of fee-based parking areas, parking garages etc., always connected to passenger cars, or also the use of wellness areas and amusement parks etc. without car.

On the one hand, public transport agencies for example want to keep their costs of selling, controlling and billing transportation permits, such as for example tickets, as low as possible. On the other hand, the agencies want to make sure that the customers have an inhibition level which is as low as possible for buying and using these permits. Based upon these intentions, methods for the electronic ticketing and the “Open Payment” were developed in the past, which can be used for example in the public transport in form of so called check-in/check-out systems (such as for example the system “Touch and Travel” of the German Railway) or in form of so called be in/be out systems (such as for example the system esprit of the mcity GmbH).

Today's systems for the electronic ticketing have the common disadvantages that on the one hand they cause significant installation and operation costs for the agency, for example in form of validation devices or communication spots, and that on the other hand an active collaboration of the user is required and thus they entail the risk of wrongful or fraudulent handling. Additionally, today's systems have usually been developed for particular means of transport, such as for example for railway and bus trips and cannot be simply transferred to complementary means of transport, such as for example bike sharing or car sharing systems and neither to flanking cost positions such as parking and toll fees.

### SUMMARY OF THE INVENTION AND DESCRIPTION OF THE PREFERRED EMBODIMENTS

Based upon the above described state of the art, an aspect of the present invention to provide a method for the automated detection of a local position of a person, which method enables a largely automated detection of the use of chargeable services and can be used as a base for automated billings.

Such automated billings can for example refer to locality specific tariff rates, such as for example rates of the first or second class seats of a train which are determined by the stay in a particular railway-compartment, a particular area in a parking garage, a particular tariff rate of a taxi, etc.

According to a feature of the invention, geographic data are combined with supplementary information of the same period of time. The supplementary information is at least one of the acceleration information and/or surrounding field information.

The combined data are then evaluated by means of memorized reference data.

Geographic data are coordinates information (longitude and latitude) which define the detected locality. Such information can be obtained from satellites or corresponding alternative systems. Radio cell information can also be evaluated. An altitude sensor as well as local-based-services of commercial providers can be efficiently evaluated. Separate local information can also be evaluated. It is even imaginable to position radio emitters comprising local information for the purpose according to the invention.

According to an advantageous proposal of the invention, geographic data will be extrapolated in case of a malfunction.

The acceleration and surrounding field information are detected by the sensor technology in the mobile terminal and combined as required. The sensory information comprises acceleration information, angular velocities (“gyroscopic sensor”), altitude information with respect to the mean sea level or other height references, acoustic values such as noise levels which are detected by a microphone and/or temperature values. It becomes apparent that this sensory information can be for example detected by a commercial smart phone. It is furthermore also imaginable to use additional sensors which are made available by extensions of the hardware.

The continuously collected sensory information is compared to reference data which are respectively characteristic of particular local positions, such as for example a ride on a commuter train.

According to an aspect of the invention, the reference data for sensory information permit to conclude local positions and means of locomotion from the sensory information actually collected. Herein, the different available information sources (sensors) can be combined in different ways depending on the respective application case. From particular acceleration values and noise levels, the conclusion could be for example drawn with a certain probability that the mobile terminal is located in a certain high-speed train.

Information of any kind is also collected under the term surrounding field information, which information can be additionally transmitted to the terminal as electronic data. Herein, the said information can comprise the evaluation of WLAN data, the evaluation of local web services and internet services and the like.

Schedules, time-tables of events and the like fall within this scope. According to the invention, they can be complemented by real-time information, for example schedule modifications, real schedules and the like.

Due to the combination of the geographic data with an evaluation of the acceleration and surrounding field information it is for example possible to determine whether a person is located in a particular train, in a particular bus or at a particular station. It is possible to determine whether the person is located at a particular parking area. Here, a start and end time can be for example detected, on the base of which it results that the time in between is a parking period.

According to an aspect of the invention, the data can be collected by means of a modern commercial mobile terminal. Thus, for example up to date smart phones or other mobile telephone terminals can be used or comparable devices such as GPS navigation devices etc. can be adapted.

The present invention also discloses a method for detecting the use of means of transportation and chargeable localities, such as for example parking garages, in an automatic way on the base of commercial sensor technology in mobile terminals, such as for example “smart phones”, and for providing this information as base for the determination of tariffs and prices as well as their billing. If this method is used, an additional mobile device for the determination of the tariff as well as the user's active authentication is usually no more required.

The preferred method is based upon the following methodic elements. After having activated the method on the mobile terminal, geographic data and sensory information, such as acceleration information and/or surrounding field information, is continuously collected. If neither satellite nor radio supported local information is available during the detection of the movement profile, these interruptions will be extrapolated—until a certain period of time is reached and as long as the means of transportation changes according to the sensor technology. On the base of the geographic data, evident movement profiles are made, while the sensory information is compared to sensory information reference data in regular time intervals in order to draw possible evident conclusions with respect to the local position, such as for example a particular train or bus type.

Herein, the reference data are either locally memorized in the terminal or made available via a background system in a similar way to the one which is usually used for acoustic reference information for sound profiles in order to draw conclusions with respect to interpreters and titles of a recorded music.

The reference data for the use of a service can also be determined from dynamic real-time information which comes for example from the mobile terminals of other customers who are using this service. Thus, for example the sudden braking of a bus could be used on the base of a detection by the mobile terminal of a user who is known to use the bus, in order to determine in how far other users use the same bus by comparing the collected information to the sensory information of these other users (braking at the same moment).

On the basis of the movement profiles and optionally also on the base of the conclusions drawn from the sensory information with respect to the type of the local position, also surrounding field information is evaluated with respect to this background. Conclusions are drawn with respect to the possibly used service from the surrounding field information together with the already collected sensor and geo data. The schedules and real-time riding information of a local train on a particular route are for example classified as relevant surrounding field information, if geographic data and sensory information allow drawing the conclusion with respect to this means of transportation and this route. Alternatively, also the tariffs of a taxi enterprise or of a parking garage could be for example such surrounding field information which is collected for evaluation on the base of the geographic data and sensory information.

If the above described extrapolation in case of a malfunction is no more possible, the automated detection of the use of the means of transportation will be no more possible. The user will then be requested to actively prove his local position by means of one of several pre-defined methods. This is for example an NFC based terminal comprising local information in the form of a validation device.

On the basis of the described methodical elements, a profile is preferably generated in a background system, which profile continuously provides the local positions and the services used for these ones for the period of activation of the method. This information can be used for billing purposes in the next step. The user can view in real-time the information by the used means of transportation and can, as necessary, manually introduce interruptions. The recognition of flanking costs such as parking garage and toll fees can also be taken into account in the billing.

The surrounding field information which has been additionally collected by the sensor technology of the mobile device is anonymously memorized on a server for a continuous updating of the reference data. Thus, it is assured that modifications of the reference data for the use of a means of transportation (such as they can be for example caused by a new generation of high speed trains) are quickly detected and considered in all the following evaluations.

What is claimed is:

1. A method for the automated detection of a local position of a person equipped with a suitable terminal, comprising:
wherein at times which are respectively adjusted to each other
a) geographic data, as well as
b) acceleration information, and
c) at least one surrounding field information item of the type selected from:
local information, and/or
acoustic values, and/or
temperature values, and/or
information provided by WLAN
are collected, which are then evaluated by means of memorized reference data including acceleration and surrounding field information which are respectively characteristic of particular local positions.

2. The method according to claim 1 wherein satellite signals and/or mobile radio cell information are evaluated for the collection of geographic data.

3. The method according to claim 1 wherein altitude sensors are evaluated for the collection of geographic data.

4. The method according to claim 1 wherein “Local based Services” by commercial providers are evaluated for the collection of geographic data.

5. The method according to claim 1 wherein geographic data are extrapolated in case of a malfunction.

6. The method of claim 1 wherein sensors for measuring the acceleration and/or angular velocity are evaluated for detecting the acceleration.

7. The method according claim 1 wherein the reference data comprise planned information.

8. The method according to claim 1 wherein the reference data comprise real-time information.

9. The method according to claim 1 wherein the reference data are information which comes from the mobile terminal of a person who uses this service.

10. The method according to claim 1 wherein a mobile terminal is used for the collection of data or information.

11. The method according to claim 1 wherein the evaluation of data comprises information about the use of means of transportation.

12. The method according to claim 1 wherein, after the evaluation of data, the person is requested to give a confirmation of the result.
